(19) United States
(12) Patent Application Publication
(10) Pub. No.: US 2008/0042084 A1
(43) Pub. Date: Feb. 21, 2008

(54) Hybrid Micro/Macro Plate Valve

(76) Inventor: Edward Nelson Fuller, Manchester, MI (US)

Correspondence Address: MACMILLAN SOBANSKI & TODD, LLC, ONE MARITIME PLAZA FIFTH FLOOR, 720 WATER STREET, TOLEDO, OH, 43604-1619, US

(21) Appl. No.: 10/589,599

(22) PCT Filed: Feb. 25, 2005
(86) PCT No.: PCT/US05/05963

§ 371 Date: Jul. 2, 2007

Related U.S. Application Data
(60) Provisional application No. 60/548,563, filed on Feb. 27, 2004.

(51) Int. Cl. F16K 31/00

(52) U.S. Cl. 251/26

(57) ABSTRACT

A microvalve device includes a pilot valve and a pilot operated valve. The pilot valve includes a first layer having openings and a second layer having a chamber in communication with the openings, and a movable member for controlling fluid flow. The pilot operated valve includes three plates. Two the openings, and pressure apply and release channels in communication with a spool portion of the pilot operated valve. The spool is movable to allow from a second fluid source to a load. The third plate includes a first source port in communication with a first fluid, the pressure apply and release channel, one of the first plate ports, one of the openings, a first port in communication with a first reservoir, a second port is in communication with the second fluid source and a load port in communication with a load.

The present invention relates in general to control valves and to semiconductor electromechanical devices, and in particular, to a micromachined control valve for a variable displacement gas compressor.

MEMS (MicroElectroMechanical Systems) is a class of systems that are physically small, having features with sizes in the micrometer range. These systems have both electrical and mechanical components. The term “micromachining” is commonly understood to mean the production of three-dimensional structures and moving parts of MEMS devices. MEMS originally used modified integrated circuit (computer chip) fabrication techniques (such as chemical etching) and materials (such as silicon semiconductor material) to micromachined these very small mechanical devices. Today there are many more micromachining techniques and materials available. The term “microvalve” as used in this application means a valve having features with sizes in the micrometer range, and thus by definition is at least partially formed by micromachining. The term “microvalve device” as used in this application means a device that includes a microvalve, and that may include other components. It should be noted that if components other than a microvalve are included in the microvalve device, these other components may be micromachined components or standard sized (larger) components.

Various microvalve devices have been proposed for controlling fluid flow within a fluid circuit. A typical microvalve device includes a displaceable member or valve movably supported by a body and operatively coupled to an actuator for movement between a closed position and a fully open position. When placed in the closed position, the valve blocks or closes a first fluid port that is placed in fluid communication with a second fluid port, thereby preventing fluid from flowing between the fluid ports. When the valve moves from the closed position to the fully open position, fluid is increasingly allowed to flow between the fluid ports. U.S. Pat. No. 6,540,203 entitled “Pilot Operated Microvalve Device”, the disclosures of which are hereby incorporated herein by reference in their entirety, describes a microvalve device consisting of an electrically operated pilot microvalve and a pilot operated microvalve of which its position is controlled by the pilot microvalve. U.S. Pat. No. 6,494,804 entitled “Microvalve for Electronically Controlled Transmission”, the disclosures of which are hereby incorporated herein by reference in their entirety, describes a microvalve device for controlling fluid flow in a fluid circuit, and includes the use of a fluid bleed path through an orifice to form a pressure divider circuit.

In addition to generating a force sufficient to move the displaced member, the actuator must generate a force capable of overcoming the fluid flow forces acting on the displaceable member that oppose the intended displacement of the displaced member. These fluid flow forces generally increase as the flow rate through the fluid ports increases.

A gas compressor will change a state of a gas from a low-pressure state to a high-pressure state. Such a compressor is often used in air-conditioning (A/C) systems utilizing a refrigerant gas.

The refrigerant gas is discharged by the compressor at a high pressure (the discharge pressure). The gas moves to a condenser, where the high pressure, high temperature gas condenses into a high pressure, low temperature liquid, the energy released from the gas during the state change (the latent heat of condensation) being transferred to air (or another cooling medium) passing over the condenser fins in the form of rejected heat. From the condenser, the liquid travels through an expansion device, which controls the rate of flow of the liquid refrigerant, to an evaporator where the refrigerant evaporates and expands. The air passing over the evaporator coils gives off its heat to the refrigerant, providing energy needed for the state change of the refrigerant (the latent heat of vaporization). The cooled air passes out into the compartment to be cooled. The degree to which the air is cooled is proportional to the rate of expansion of the refrigerant gas, and the rate of expansion of the gas is related to how the rate at which the refrigerant gas is compressed within the compressor. The pressure of the gas is controlled within the compressor by the amount of displacement of the piston within the compression chamber.

A key concern in designing a cooling system utilizing refrigerant gas is too ensure that the liquid from the condenser does not flow in a quantity and temperature to push the evaporator below the freezing point of water. If there is too much heat absorption by the gas within the evaporator, the water found on the fins and tubes through condensation of water from air passing over the evaporator will freeze up, choking off air flow over the evaporator, thereby cutting off the flow of cool air to the passenger compartment of a vehicle, for example, or other area to be cooled. For this reason, most conventional control valves are calibrated to change the stroke (displacement) of the compressor based on the pressure of the gas returning to the compressor at a set pressure of the gas. The gas returns to the suction area of the compressor. The pressure in this area of the compressor is known as the suction pressure. The desired suction pressure, around which the stroke of the compressor is changed, is known within the art as the set-point suction pressure.

In 1984, a variable displacement refrigerant compressor was introduced which adjusted the flow of the refrigerant gas through the system by varying the stroke of the piston in the pumping mechanism of the compressor in the manner just described. This system was designed for use in an automobile, deriving power to drive the compressor using a drive belt coupled to the vehicle's engine. In operation, when the A/C system load is low, the piston stroke of the compressor is shortened so that the compressor pumps less refrigerant per revolution of the engine drive belt. This allows just enough refrigerant to satisfy the cooling demands of the automobile's occupants. When the A/C system load is high, the piston stroke is lengthened and pumps more refrigerant per revolution of the engine drive belt.

A description of this prior art variable displacement compressor and a conventional pneumatic control valve (CV) is found in U.S. Pat. No. 4,428,718 to Skinner (hereinafter Skinner '718) which is assigned to the General Motors Corporation of Detroit, Mich. The disclosures of Skinner '718 are hereby incorporated herein by reference in their entirety.

An alternate CV design used in variable displacement compressors for vehicle air conditioning system utilizes a solenoid-actuated valve to control the flow of refrigerant gas into the crankcase of a variable displacement compressor. U.S. Pat. No. 5,964,578 to Suitou, et al (hereinafter Suitou '578), the disclosures of which are hereby incorporated herein by reference in their entirety, discloses a CV having a solenoid-activated rod that operates on a valve member that controls the flow of discharge and suction pressure gasses to the crankcase. The valve member position is partially established by a spring-biased bellows in similar fashion to a conventional pneumatic CV. Increasing suction pressure acts on the bellows to reduce gas flow from the discharge area to the crankcase. When energized, the solenoid activated rod applies a force that also urges the valve member so as to reduce discharge pressure flow to the crankcase. This allows an additional control of the piston stroke and the output capacity of the compressor that can be mediated by electrical signals to the solenoid coils.

An alternate CV design using a solenoid actuator to control discharge valve operation has been disclosed in U.S. Pat. No. 5,702,235 to Hirota (hereinafter Hirota '235), the disclosures of which are hereby incorporated herein by reference in their entirety. In this design, a solenoid is used to open and close a pilot valve that admits discharge pressure gas to a pressurizing chamber in the CV. The pressurizing chamber is in constant gas communication with the suction pressure area of the compressor. A valve member controls the flow of discharge and suction pressure gasses to the crankcase. The position of the valve member is established by a balance of spring bias forces, the force of the discharge pressure acting on an end of the valve member, and the force of the pressure in the pressurizing chamber acting on the opposite end of the valve member. When energized, the solenoid activated pilot valve allows the pressure to rapidly increase in the pressurizing chamber, opening the valve member to increase the flow of discharge pressure gas to the crankcase.

The valve member of the Hirota '235 CV design does not respond to the suction area pressure and does not control compressor displacement according to a suction pressure set-point as does the solenoid-assisted CV of Suitou '578 or the pneumatic CV of Skinner '718. The object of the Hirota '235 CV design is to use the force of discharge pressure gas to open the discharge to crankcase valve, thereby allowing the use of a compact, lightweight and inexpensive solenoid.

### SUMMARY OF THE INVENTION

There are several disadvantages with the prior art solenoid-assisted CV's. Among these being that the size of the solenoid valves used, which limit the packaging options for the cooling system in which they are installed. One solution that has been proposed is described in co-pending U.S. patent application Ser. No. 60/525,225 by Chancey et al., the disclosures of which is incorporated herein by reference in their entirety. Another solution is that which is suggested by the following disclosure.

The present invention relates to a microvalve device including a microvalve pilot valve and a pilot operated valve. The microvalve pilot valve includes a first layer, a third layer having a plurality of openings formed therethrough, and a second layer positioned between the first and third layer. The second layer includes a chamber in fluid communication with the openings, and includes a movable member for selectively controlling fluid flow through the chamber and between the openings. The pilot operated valve includes a first plate, a third plate, and a second plate positioned between the first plate and the third plate. The first plate includes a plurality of ports in fluid communication with the openings of the microvalve, a pressure apply channel, and a pressure release channel. The second plate includes the pressure apply channel and the pressure release channel, both of the channels being in fluid communication with a spool portion of the pilot operated valve. The spool portion is selectively movable to allow flow from a second source of fluid to a load. The third plate includes a first source port in fluid communication with a first fluid source, the pressure apply channel, one of the first plate ports, and one of the microvalve openings. A first reservoir port of the third plate is in fluid communication with a first reservoir, the pressure release channel, one of the first plate ports, and one of the microvalve openings. A second source port of the third plate is in fluid communication with the second source of fluid. A load port of the third plate is in fluid communication with the load.

Alternatively, a microvalve for controlling the operation of another valve is disclosed. The microvalve includes a plurality of layers defining a body where the body has a chamber and a plurality of ports in fluid communication with the chamber. A movable portion is positioned within the chamber, the movable portion being selectively moved to one of allow fluid flow from a fluid source through the chamber to control the another valve, and to allow fluid flow from the another valve to a fluid reservoir. The another valve is moved to a first position when there is fluid flow from the fluid source through the chamber, and the another valve is moved to a second position when there is fluid flow from the another valve through the chamber.

Alternatively, a plate valve is disclosed. The plate valve includes a first plate defining a plurality of ports connected with a second plate. The second plate defines a chamber with the chamber having a spool positioned therein. The spool is movable between a first position and a second position. A plurality of fluid channels are in fluid communication with the plurality of ports. A third plate includes a first port connected with a first source of fluid, and a second port connected with a reservoir. The third port is connected with a second source of fluid and a fourth port is connected with a load. One of the fluid channels connects the first source of fluid with one of the plurality of openings of the first plate and the spool. Another one of the fluid channels connects the reservoir with one of the openings of the first plate and the spool. The movement of the spool is caused by at least one of the fluid moving from the first source of fluid to the spool, and from the spool to the reservoir. Movement of the spool creates a fluid path between the second source of fluid and the load.

Various objects and advantages of this invention will become apparent to those skilled in the art from the following detailed description, when read in light of the accompanying drawings.

### BRIEF DESCRIPTION OF THE DRAWINGS

FIG. 1 is an exploded perspective view of the valve assembly according to the present invention

FIG. 2 is a plan view of a layer of a microvalve in a first position used with the valve assembly according to the present invention.

FIG. 3 is a plan view of the layer of the pilot microvalve illustrated in FIG. 2 shown in a second position.

FIG. 4 is a plan view of the layer of the pilot microvalve illustrated in FIG. 2 and 3 shown in a third position.

FIG. 5 is an enlarged perspective view of a front side of the middle layer of the valve assembly shown in FIG. 1.

FIG. 6 is an enlarged perspective view of a back side (opposite the front side shown in FIG. 5) of the middle layer of the valve assembly shown in FIGS. 1 and 5.

FIG. 7 is a plan view of the first side of the middle layer of the valve assembly shown in FIG. 1 with a spool of the valve in a first position.

FIG. 8 is a plan view of the middle layer of the valve assembly shown in FIG. 7 with the spool in a second position.

FIG. 9 is a plan view of an alternate embodiment of a valve assembly utilizing a microvalve according to the present invention.

FIG. 10 is a plan view of the center plate of the valve assembly shown in FIG. 9.

FIG. 11 is a plan view of an alternate embodiment of a center plate of a valve assembly that can be used with the valve assembly shown in FIG. 9.

### DETAILED DESCRIPTION OF THE PREFERRED EMBODIMENTS

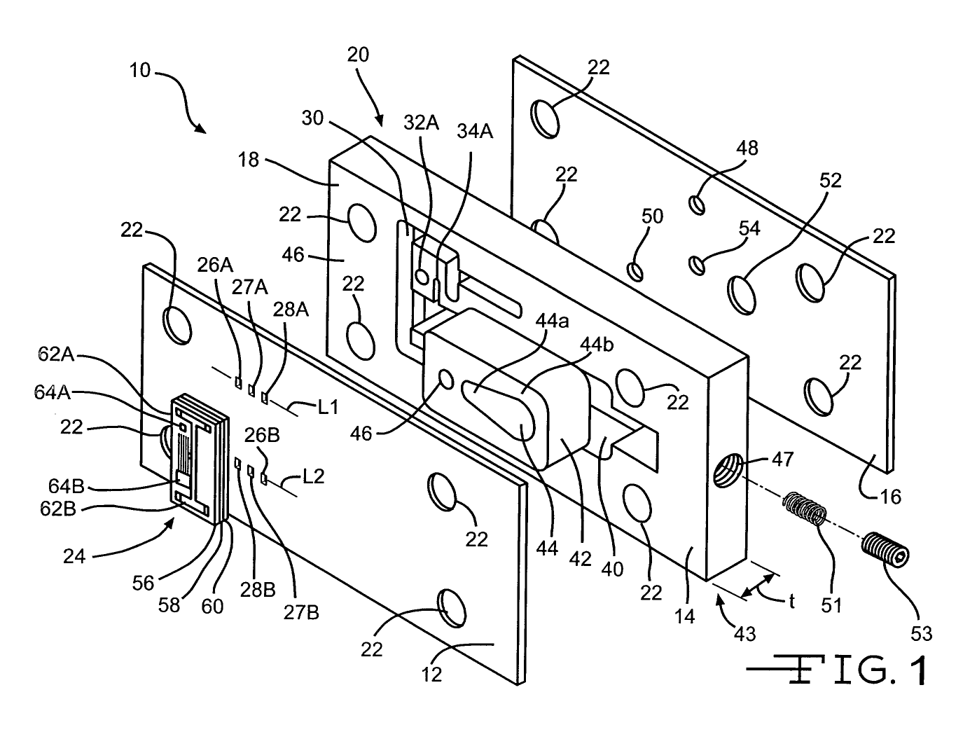

Referring now to the drawings, there is illustrated in FIG. 1 a valve assembly, indicated generally at 10, according to the present invention. The valve assembly includes a first layer (cover plate) 12, a second layer (center plate) 14, and a third layer (port plate) 16. As will be described in greater detail below, the first layer 12, having a substantially rectangular shape, is a cover plate having a plurality of openings formed therethrough, and having a microvalve 24 attached thereto. The second layer 14 has a substantially rectangular shape and a size that corresponds to the first layer 12, and also includes a plurality of openings formed therethrough, as well as a plurality of channels formed on both the front surface 18 and back surface 20 of the second layer 14, as will be described in more detail below. The third layer 16, having a substantially rectangular shape and a size that corresponds to the first layer 12 and the second layer 14, also includes a plurality of openings formed therethrough at positions that correspond to the positions of some of the openings formed through the second layer 14, as will be described in more detail below.

In the illustrated embodiment, each of the layers 12, 14, and 16, include four relatively large holes 22 formed therethrough. Each of these holes 22 preferably is substantially disposed adjacent the four corners of the substantially rectangular layers 12, 14, and 16, but can be at any suitable location. The holes 22 are used as bore holes for a fastener for securing each of the layers 12, 14 and 16 together, as well as for attaching the valve assembly 10 to another device, containing or connecting with the balance of the fluid system of which the valve assembly 10 is a part. The openings formed in the center plate 14 and the port plate 16, including the holes 22, may be formed by any suitable method such as etching, conventional or laser drilling, milling, or other suitable machining method. Similarly, the channels formed in the center plate 14 can be formed by any suitable process, such as a milling process or by etching. It is preferred that the openings formed on the cover plate, including the holes 22, are formed by etching. It can be appreciated, however, that any of the openings and channels can be formed using any suitable process. The layers 12, 14, and 16 may be formed by any suitable means. For example, the layers may be formed by being cut from metallic sheet stock or being machined from individual blanks. The various holes and channel features can be formed thereon subsequently by machining or etching, or otherwise forming, those features into the layers 12, 14, and 16. Alternatively, the various holes and channel features, or other desired features, may be formed in the layers 12, 14, and 16 coincident with the initial fabrication of the layers 12, 14, and 16 during a casting or molding process. Such features can also be formed using any similar process, or any suitable combination of molding, casting, machining, etching processes. The layers 12, 14, and 16 may be made of any suitable material, such as a ceramic, crystalline, composite, metal, plastic, or glass material. In a preferred embodiment, the layers 12, 14, and 16 are metallic, with steel being suitable for some anticipated applications.

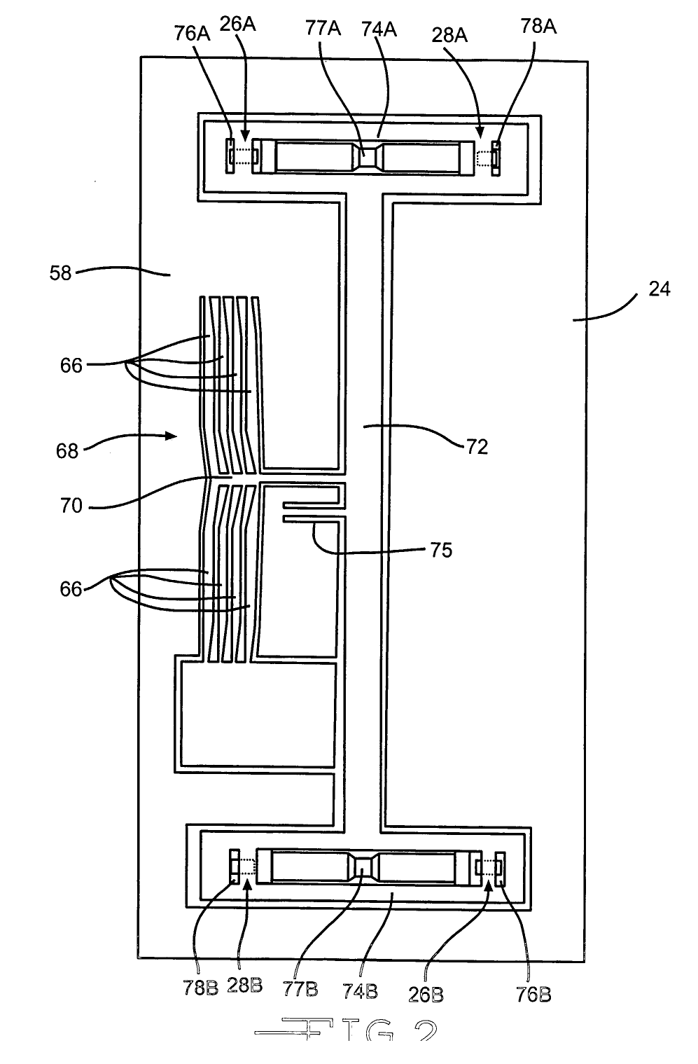

The openings formed in the cover plate 12 are preferably positioned on the cover plate 12 such that the openings are substantially aligned with passageways formed in the microvalve 24. More specifically, a first set of ports, 26A, 27A, and 28A, are preferably aligned along an upper portion of the cover plate 12 such that each port 26A, 27A, and 28A is positioned along a common line L1. Similarly, a second set of ports, 26B, 27B, and 28B, are preferably aligned along a lower portion of the cover plate 12 such that each port 26B, 27B, and 28B is positioned along a common line L2. The effective distance between the first set of ports, 26A, 27A, 28A and the second set of ports 26B, 27B, 28B is such that the space between the ports corresponds to the positions of openings formed in the microvalve 24. As will be explained with respect to the operation of the microvalve 24, the ports 26A and 26B are preferably identified as being tank ports, and are interconnected as will be described below. Similarly, the ports 27A and 27B are preferably identified as being spool ports, and are interconnected as will be described below. Likewise, the ports 28A, 28B are preferably identified as being supply ports, and are interconnected as will be described below. The reasons for having the relative positions of the ports on the cover plate 12 and the passageways formed in the microvalve 24 as shown will be explained in greater detail with respect to FIG. 2. It can be appreciated, however, that the ports formed on the cover plate 12 can be arranged in any suitable fashion to connect a particular embodiment of the microvalve 24 with the suitable portions of the rest of the valve assembly 10 to achieve the desired functioning of the valve assembly 10.

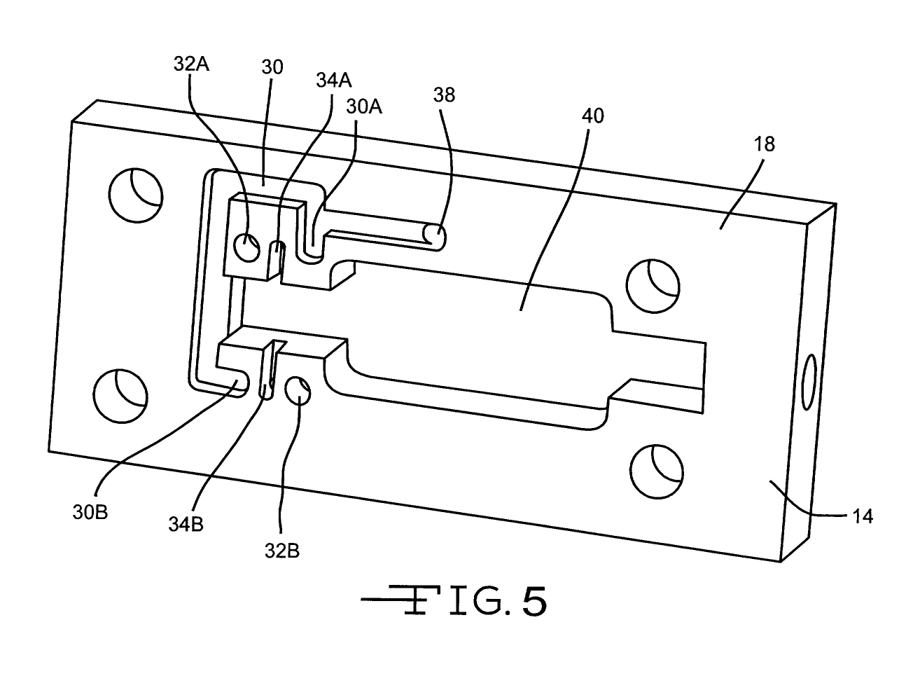

Referring now to the center plate 14 (also illustrated in FIGS. 5-8), the center plate 14 has a front surface 18 disposed adjacent the cover plate 12, and a back surface 20 disposed adjacent the port plate 16. The center plate 14 may be relatively thicker than the cover plate 12 and the port plate 16. However, such a dimensional difference is not required. Formed on the front surface 18 of the center plate 14 is a first channel 30, a pair of diagonally opposed bores 32A and 32B, and a pair of opposed ducts 34A and 34B. Formed on the back surface of the center plate 14 is a second channel 36 and a bore 38 that extends through the center plate 14 and into the first channel 30. It is preferred that the channels 30 and 36 are formed having a depth that is less than one-half the thickness of the center plate 14 such that portions of the channels 30 and 36 can be positioned on directly opposite sides of the center plate 14, if so desired, without being in fluid communication with each other. The ducts 34A and 34B can also be formed having any suitable depth, though it is preferred that the ducts 34A and 34B each have a depth that is less than the thickness of the center plate 14. The second channel 36 is in fluid communication with the bores 32A and 32B for a purpose that will be described below. Both of the ducts 34A and 34B are in fluid communication with a cut out portion 40 of the center plate 14. It should be appreciated that the channels 30, 36, ducts 34A, 34B, and bores 32A, 32B are part of a first fluid circuit that is in communication with the microvalve. The operation of the first fluid circuit will be described below.

The cut out 40 is substantially centrally located on the center plate 14 and is sized to receive a spool 42. The spool 42 is substantially rectangular in shape and has a teardrop shaped opening 44 formed therethrough such that the opening 44 has a narrower end and a wider end. It is preferred that the thickness of the spool 42 is slightly less than the thickness of the center plate 14 such that the spool 42 can move axially within the cut out 40 of the center plate 14. Also formed through the spool is a bore 46 that is spaced apart from the narrower end of the teardrop opening 44 that acts a pressure balancing device. The spool 42 is biased towards the ducts 34A and 34B of the center plate 14 by a spring 51 that acts on a side face 47 of the spool 42. The spring is retained within the center plate by a plug 53. A fluid of the first fluid circuit entering the cut out 40 via the ducts 34A and 34B preferably acts on the opposite side face 49 of the spool 42. Thus, as will be explained below, fluid pressure will force the spool 42 against the bias of the spring 51 to create a second fluid circuit between a second source of fluid and a load.

Referring now to the port plate 16, there is a supply bore 48, a tank bore 50, a load bore 52 and a discharge bore 54 formed therethrough. The supply bore 48 is preferably connected to a first source of fluid (not shown). The tank bore 50 is preferably connected to a first reservoir or tank (not shown). The supply bore 48 and tank bore 50 are preferably implemented as a part of the first fluid circuit controlled by the microvalve 24. The load bore 52 and discharge bore 54 are part of the second fluid circuit controlled by the spool valve 43. The discharge bore 54 is preferably connected to the discharge end of a pressurized fluid source (not shown). The load bore 52 is preferably connected to a hydraulically operated load. In a preferred embodiment, the load bore 52 is connected to a crankcase of a variable displacement compressor. An example of a compressor that can be adapted to work with the present invention is disclosed in U.S. Pat. No. 6,390,782 to Booth et al., the disclosures of which is incorporated herein by reference in their entirety. The combination of the compressor and control valve of the '782 patent with a microvalve used with the control valve is shown in U.S. Provisional Patent Application Ser. No. 60/525,224, the disclosures of which is also incorporated herein by reference in their entirety. It should be appreciated that any hydraulically operated device could be operably connected with the valve assembly 10 according to the present invention for operation therewith.

Next, the structure and operation of the valve assembly 10 in relation to the first fluid circuit will be described. A microvalve device for controlling fluid flow in a fluid circuit is shown generally at 24 in FIG. 1. The microvalve device 24 includes first, second and third plates 56, 58, and 60, respectively. The second plate 58 of the microvalve 24, and a portion of the third plate 60 visible through the openings of the second plate 58, are shown more clearly in FIGS. 2-4. The second plate 58 is attached to and between the first and third plates 56, 60. Preferably, each plate 56, 58, 60 is made of semiconductor material, such as silicon. Alternatively, the plates 56, 58, 60 may be made of any other suitable material, such as glass, ceramic, aluminum, or the like.

In this disclosure, reference is sometimes made to a valve being “closed” or a port being “covered or “blocked”. It should be understood that these terms mean that flow through the valve or the port is reduced sufficiently that any leakage flow remaining will be relatively insignificant in applications in which the microvalve devices described herein should be employed.

The first plate 56 of the microvalve 24 includes a pair of openings 62A and 62B that open to a corresponding pair of electrical contacts 64A and 64B disposed on the second plate 58. The electrical contacts 64A, 64B contact the second plate 58 and are adapted for connection to a suitable power source (not shown) for providing an electrical current between the contacts 64A and 64B. When the electrical contacts 64A, 64B are electrically energized, electrical current passes between the electrical contacts 64A, 64B through the ribs 66 of the actuator 68. In turn, the ribs 66 thermally expand. As the ribs 66 expand, the ribs 66 elongate, which in turn causes the spine 70 to be displaced. By regulating the amount of current supplied through the ribs 66, the amount of expansion of the ribs 66 can be controlled, thereby controlling the amount of displacement of the spine 70. Actuation of the microvalve is substantially similar to the actuation mechanism described in U.S. Pat. No. 6,637,722 to Hunnicutt and PCT Patent Publication WO 01/71226, the disclosures of which are incorporated herein by reference in their entirety. Similarly, movement of an elongate beam attached to the spine is also substantially similar to that which is described in the '722 patent. Formed in the third plate 60 of the microvalve 24, are a plurality of openings corresponding to the ports 26A, 26B, 27A, 27B, 28A, and 28B formed on the cover plate 12 of the valve assembly 10. The openings formed on the third plate 60 of the microvalve 24 are selectively covered and uncovered based on the position of a slider portion of the beam, described below.

Movement of the spine 70 in turn causes flexure of an elongate beam 72. This causes movement of a pair of opposed blocker ends 74A and 74B attached to opposite ends of the elongate beam 72. In the illustrated embodiment the beam 72 has a substantially I-shape. However, it can be appreciated that the beam 72 can have any suitable and desired shape. The beam 72 pivots about a hinge 75 for moving the blockers 74A and 74B. The movement of the blockers 74A and 74B selectively allows flow through the ports of the microvalve 24, thus acting as a pilot for the spool valve 43. In the preferred embodiment, the blockers 74A, 74B slidably move between a first position, a second position, and a third position, shown in FIGS. 2, 3, and 4, respectively. Each of the blockers 74A, 74B is a substantially rectangular member having a first relatively small opening 76A, 76B formed therein, a second relatively small opening 78A, 78B formed therein, and relatively large opening 77A, 77B formed between the smaller openings. It is also preferred that the small openings on each blocker are formed at opposite ends of the respective blockers 74A, 74B.

The beam 70 and each blocker 74A, 74B acts in a substantially similar manner to that which is described in the '722 patent as the beam and blocking portion (FIG. 5A, reference numeral 136). As illustrated in FIG. 2, the valve is in the de-energized position. In this position, the microvalve 24 is open with the tank ports 26A and 26B in fluid communication with the spool ports 27A and 27B, respectively. This can be considered a pressure release position as fluid is being vented from the face 49 of the spool valve 43 to the reservoir of the first fluid circuit through the microvalve 24. As shown with respect to the upper blocker 74A, the leftmost opening 76A is in communication with the upper tank port 26A of the cover plate 12, and the center opening 77A is open to the spool port 27A. With respect to the lower blocker 74B, the center opening 77B is open to the spool port 27B on the cover plate 14 and the rightmost opening 76B is in communication with the other tank port 26B on the cover plate 14. In the microvalve position illustrated in FIG. 2, the openings 78A and 78B that are connected with the supply ports 28A and 28B on the cover plate 12, are isolated from the center openings 77A and 77B and thus the spool ports 27A and 27B.

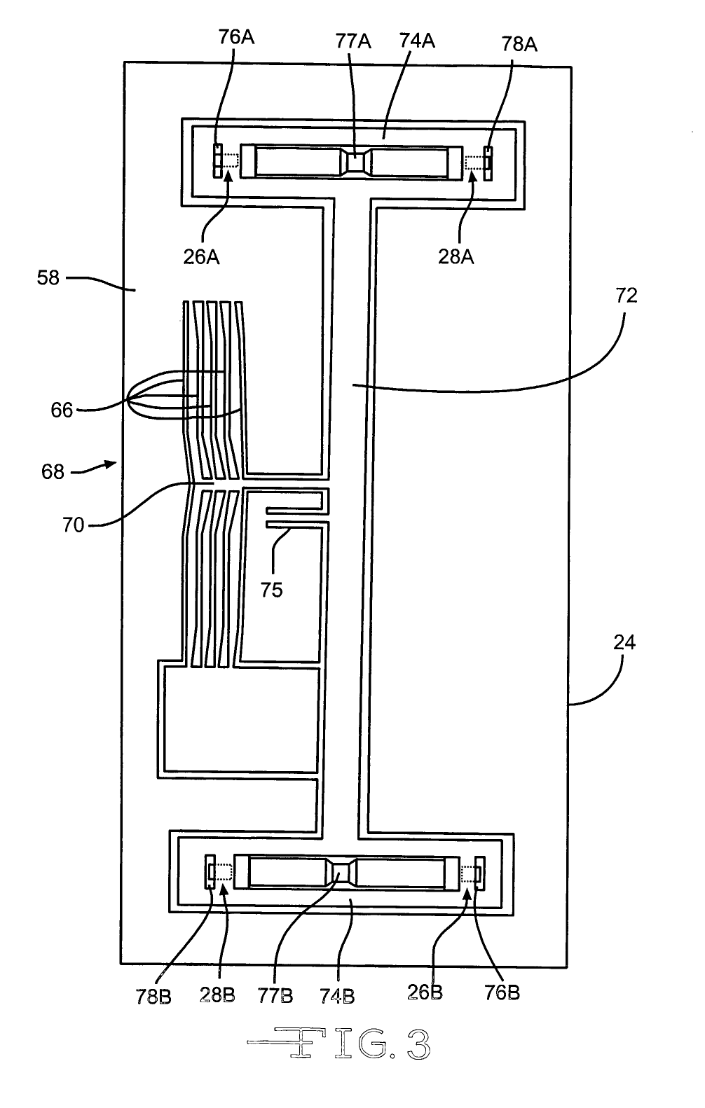

Illustrated in FIG. 3 is the microvalve 24 shown in a first energized position. When the microvalve 24 is energized, each blocker 74A and 74B moves in an opposite lateral direction. A change in the position of each blocker 74A, 74B will isolate both the supply ports 28A, 28B and the tank ports 26A, 26B from the spool ports 27A, 27B as the blockers 74A, 74B, move to cover the tank and supply ports. This is considered a pressure hold position where no flow is being supplied through the microvalve 24 to the ducts 34A, 34B, and thus to the spool valve 43. Similarly, in the pressure hold position, no flow is being supplied through the microvalve 24 from the ducts 34A, 34B, and thus from the spool valve 43, and no fluid is being vented away from the spool. Thus, the spool valve will be held in a substantially fixed position.

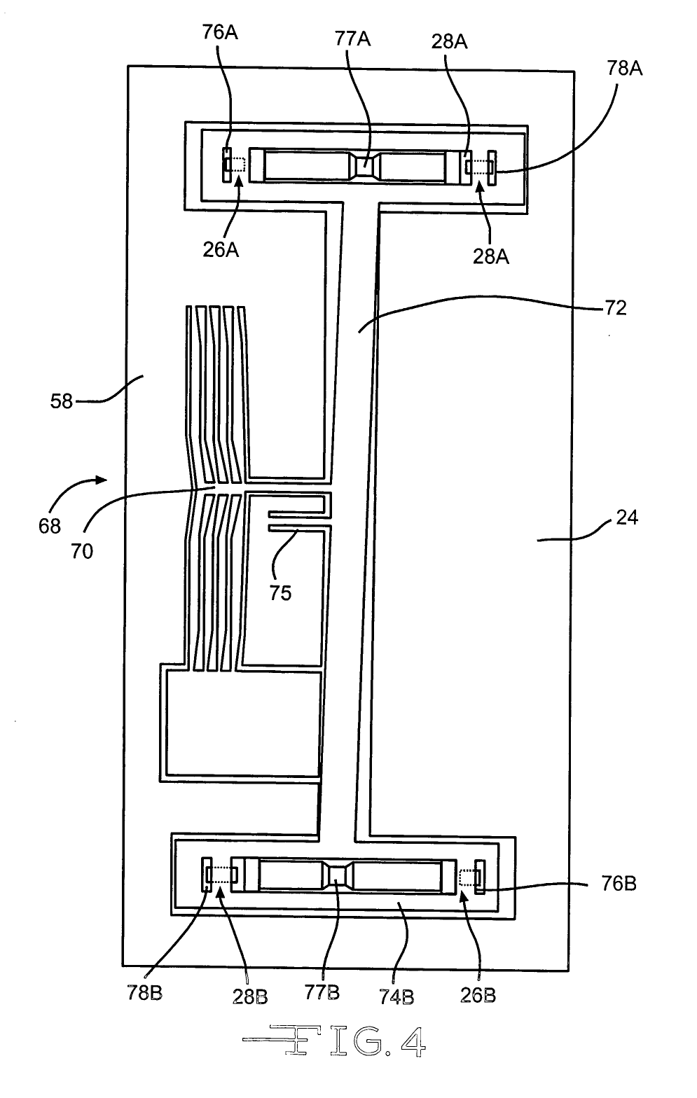

Illustrated in FIG. 4 is the microvalve 24 shown in a second energized position. The energy supplied to the microvalve will be greater than that supplied to the microvalve when in the first energized position, thus the further application of energization to the microvalve 24 will cause the blockers 74A, 74B to move further laterally. In this position, the microvalve 24 is in the pressure increase position. The pressure increase position of the microvalve places the openings 77A, 77A formed on the microvalve 24(communicating with the spool ports 27A, 27B formed on the cover plate 12) in fluid communication with the openings 78A, 78B (which are connected with the supply ports 28A, 28B formed on the cover plate 12). Fluid entering the microvalve 24 from the supply ports 28A, 28B is preferably pressurized fluid and will flow from the microvalve 24 to the ducts 34A, 34B formed on the center plate 14. Thus, in the pressure increase position, fluid will act on the side face 49 of the spool 42 to move the spool 42 against the bias of the spring.

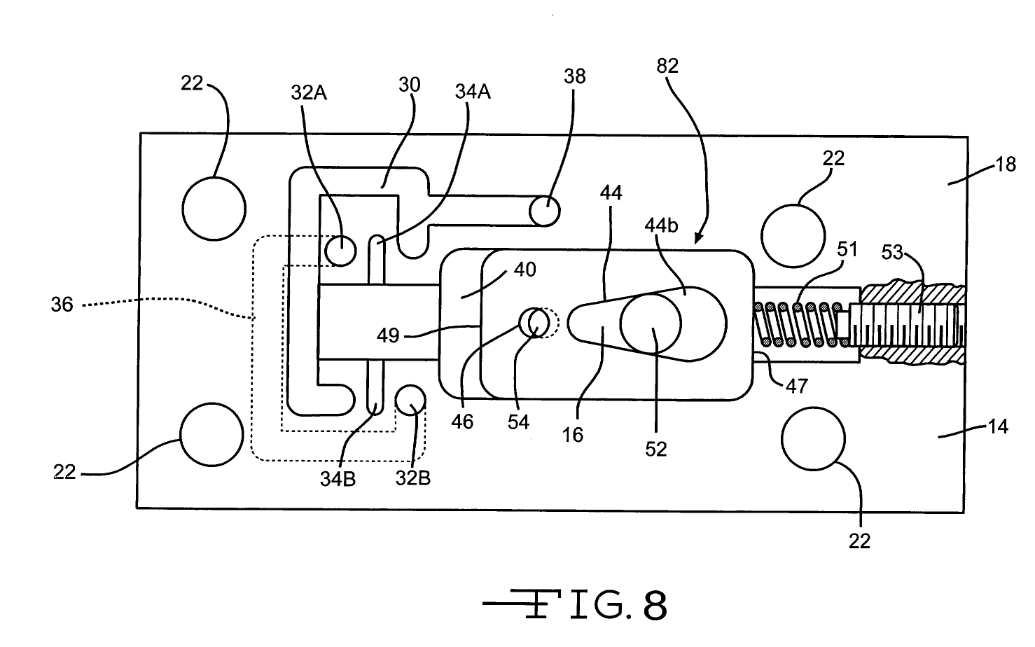

The flow path through the center plate as a part of the first fluid circuit is described next. Referring now to FIG. 5, the center plate 14, generally described above, is illustrated. When the microvalve 24 is in the pressure increase position (FIG. 4), the supply ports 28A, 28B are in are in fluid communication with the spool ports 27A, 27B, and the microvalve 24 is in the position described above. Thus, the high pressure fluid source connected to the port plate 16 via the supply bore 48 will supply fluid through the bore 38 to the channel 30. The channel 30 then directs the fluid flow through the microvalve 24 (fluid traveling in through the openings 77A, 77B of the blockers 74A, 74B) and to the spool valve 43 (fluid travels out of the microvalve 24 through the openings 28A, 28B of the microvalve). As described above, the openings 28A and 28B of the microvalve 24 are in fluid communication with fluid ducts 34A and 34B, respectively, which in turn directs the fluid flow to the side face 49 of the spool 42 to operate the spool valve 43, as is described below with respect to the second fluid circuit. The position of the spool 42 relative to the other portions of the valve assembly 10 when the spool valve 43 is in the pressure increase position is illustrated in FIG. 8. When the microvalve 24 is in the pressure increase position, the discharge bore 54 is isolated from the load bore 52 of the spool valve 43.

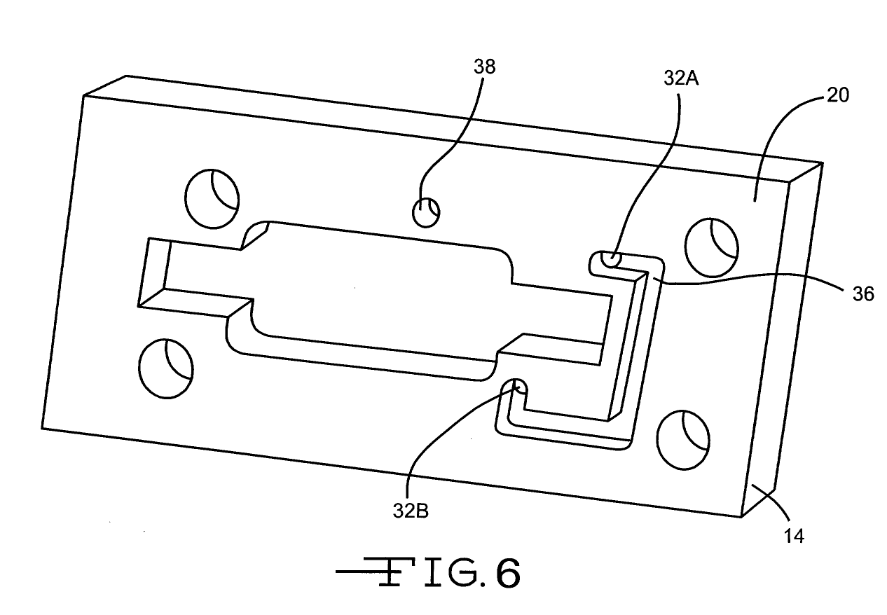

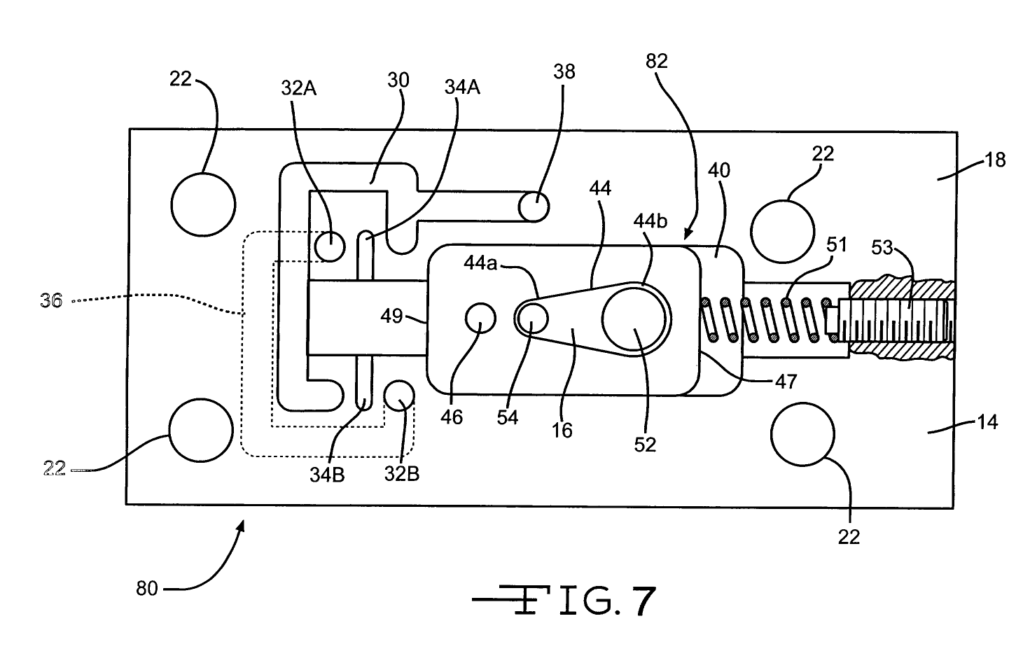

The microvalve 24 is shown in a pressure release position in FIG. 2. When the valve assembly 10 is operating under this condition, the blockers 74A, 74B move to allow fluid communication between the openings 76A, 76B over the tank ports 26A, 26B, and the openings 77A, 77B over the spool ports 27A, 27B. In the pressure release position, the fluid source connected to the source bore 48 is isolated from the channel 30 and from the spool valve 43. Thus, the discharge bore 54 is in fluid communication with the load bore 52 (illustrated in FIG. 7) and pressure is increased to the load. However, in order to release the pressure from the face 49 of the spool valve 43, the pathway through the microvalve 24 to the reservoir, or tank, is opened. Thus, fluid pressure against the spool 42 is relieved thereby allowing the spool 42 to return to its spring biased position (FIG. 7). The position of the microvalve 24 is such that the flow coming into the microvalve 24 via openings 77A, 77B will flow out through the openings 76A, 76B. From the openings 76A, 76B the fluid flow will preferably be through the ports 26A and 26B which are in turn connected to bores 32A and 32B, respectively. As is most clearly seen in FIGS. 6 and 7, the bores 32A and 32B are in fluid communication with the channel 36. The channel 36 is connected with the tank bore 50 which is connected with the tank. Thus, when the microvalve 24 is moved to a pressure release position, flow is controlled to release pressure from the spool valve 43. In this position, the second fluid circuit source of pressurized fluid is in fluid communication with the second fluid circuit load (through the center of the spool 42).

Illustrated in FIG. 3, the microvalve is positioned in a pressure hold position. In such a position, both the tank and the supply source are isolated from the load. Thus, there is essentially no flow passing through the microvalve 24. Therefore, no net fluid is flowing to the face 49 of the spool 42 thereby maintaining whatever level of fluid communication that is occurring in the second fluid circuit at a substantially constant level.

The operation of the second fluid circuit will be described next. The second fluid circuit allows fluid to flow from a source of pressurized fluid to a load. As shown in FIG. 7, the spool valve 43 is in an active position. In this position, the spring is biasing the spool 42 to the left (as shown in the Figures) and the discharge bore 54 is in fluid communication with the load bore 52 inside the opening 44. Thus, the hydraulic load can be utilized as described in the '782 patent and the '224 application, described above. As shown in FIG. 8, the spool valve is in an inactive position. In this position, fluid from the first fluid circuit will be acting upon the side face 49 of the spool 43 causing movement of the spool 42 against the bias of the spring. Movement of the spool 42 against the spring bias will cause the spool 42 to block the discharge bore 54. Thus, the discharge bore 54 will be isolated from the load bore 52 preventing flow of pressurized fluid to the load. In the spool valve 43 position illustrated in FIG. 8, the pressure balancing bore 46 will act against a lower surface (and optionally an upper surface) of the spool 42 to prevent fluid pressure from forcing the spool against the cover plate 12 and the port plate 16 which could cause the spool to bind against those plates. Thus, the spool 42 will be able to substantially smoothly slide back and forth within the cut out 40 during operation of the spool valve 43.

It should be appreciated that, in an alternate embodiment, the valve assembly 10 can be set up in a manner opposite to the manner in which the above-described valve assembly 10 has been set up, such that the microvalve 24 is normally positioned to allow fluid to flow from the source of pressurized fluid to the spool valve 43. Alternatively, the valve assembly 10 could be modified in any suitable manner to achieve any desired flow pattern in accordance with the present invention.

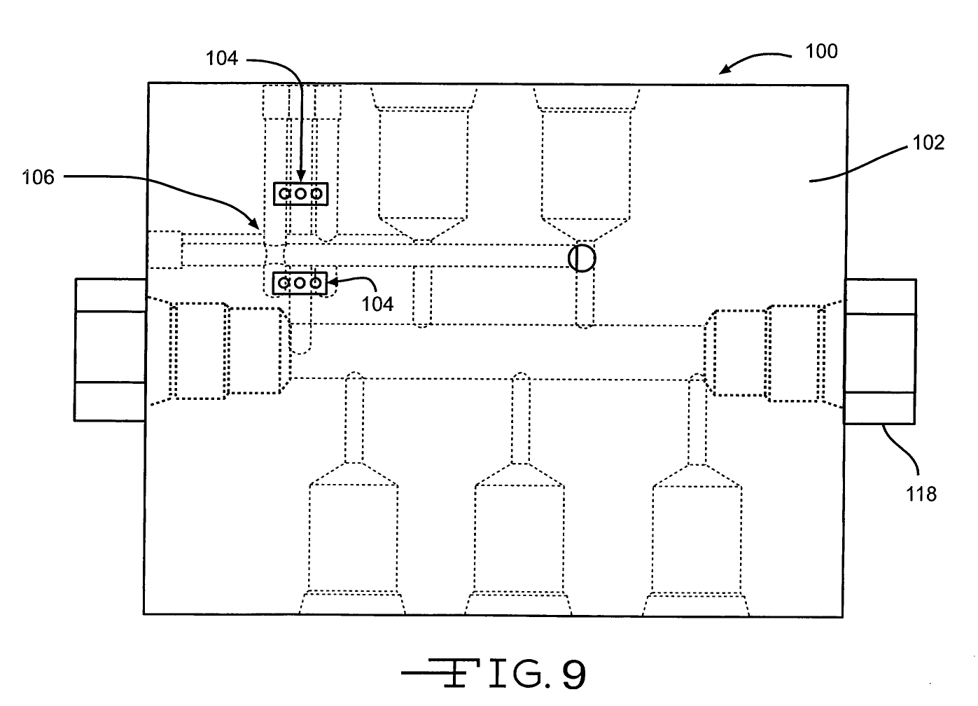

In an alternate embodiment illustrated in FIG. 9, a valve assembly, indicated generally at 100, is shown having a round spool. In this embodiment, a microvalve (not shown) that is substantially the same as described in relation to the first embodiment of the invention, is connected with a cover plate 102. Bond pads 104 are preferably formed on the cover plate 102 so that the microvalve can be more easily attached to the cover plate 102. The operation of the microvalve will preferably also be substantially the same as described above. Also formed in the cover plate are a plurality of ports, indicated generally at 106, that are substantially similar in design and operation to the ports (26A, 26B, 27A, 27B, 28A, 28B) described above with respect to the first layer 12.

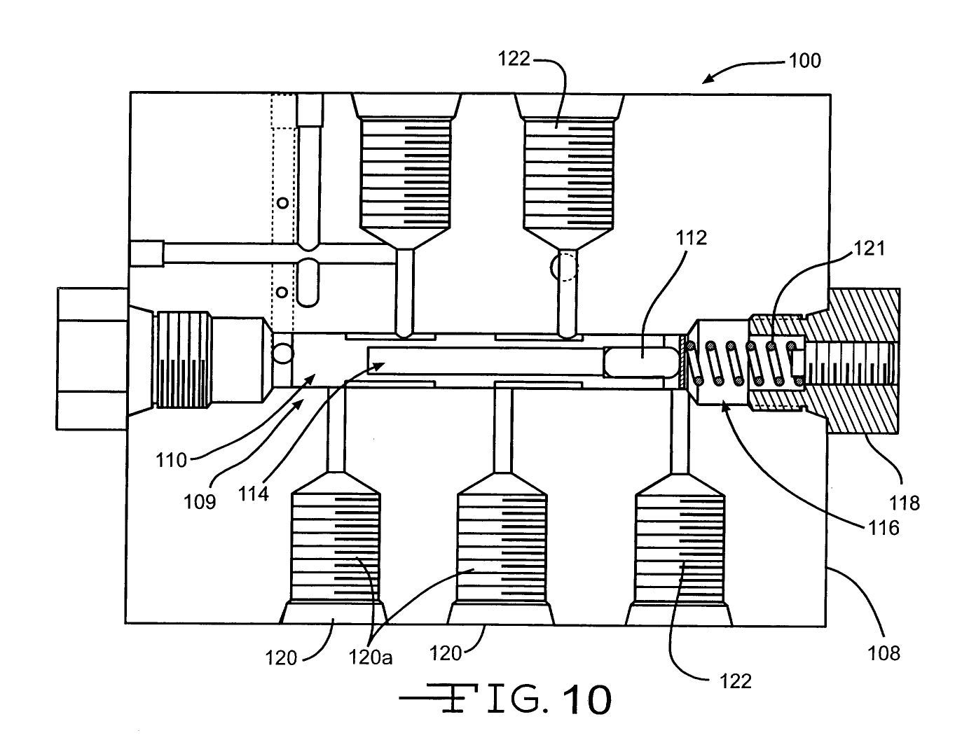

As shown in FIG. 10, there is illustrated in greater detail a center plate 108 of the valve assembly 100. There is a cavity 109 formed in a center plate 108, in which the spool 110 is received. As shown in FIG. 10, the microvalve actuator would be energized therefore applying a discharge pressure to the left end of the spool 110. The discharge pressure is also acting on the reaction pin 112 through an orifice 114 formed at the end of the reaction pin 112, and the center of the spool 110. With a discharge pressure acting on the reaction pin 112, a suction pressure, created via suction ducts 122, is created on the spring 121 in the spring cavity 116. The spring 121 can be retained with the spool valve assembly 100 by a plug 118, substantially as described above with respect to the spring 51 and plug 53. The operation of the spool valve 100 includes proportionally reducing the pressure on the left end (as viewed in FIG. 10) of the spool 110 by using the microvalve to control flow away from the spool 110. The spool 110 position can then be regulated against the force of the spring 121 and the reaction pin 112 to open a discharge pressure to the load, such as via a discharge duct 120a to a crankcase 120, and to selectively de-stroke a compressor (not shown) that is the load supplied by the valve 100. In a “no-power” failure mode, wherein there is no power supplied to the microvalve actuator, the microvalve would port suction pressure to the left end of the spool 110. The spring 121 and reaction pin 112 would therefore move the spool 110 to the left. This would fully open the discharge to the path to the crankcase 120 and would de-stroke the compressor. The spool 110 can also be moved into the position that is illustrated in FIG. 10, even when there is a low differential pressure (for example, about 10 psi discharge to suction) due to the low force on the reaction pin 112 relative to the force on the left end of the spool 110. Thus, in a manner that is similar to the embodiment described above, the ports in communication with the microvalve are also in communication with channels that supply fluid to the spool 110 to move the spool 110 against the bias of the spring 121 and reaction pin 112. By controlling the position of the spool 110, the orifice 114 supplies fluid to or from a load to a reservoir. The sources of fluid can be any suitable sources, such as those described above.

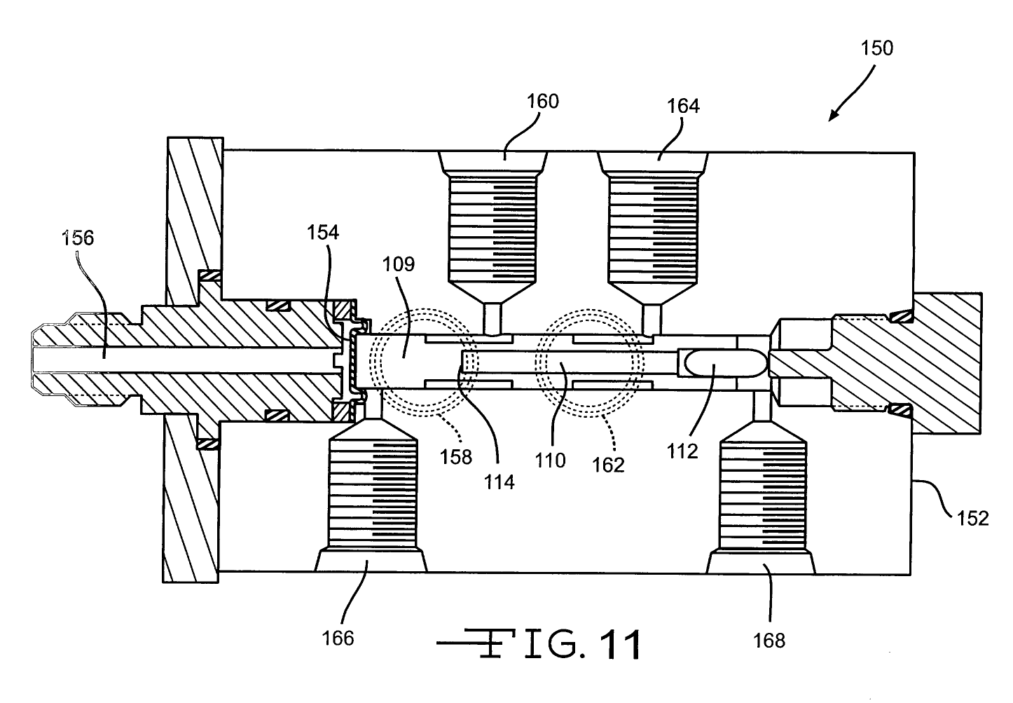

In FIG. 11, a valve assembly 150 that is substantially similar to the valve assembly shown in FIGS. 9 and 10 is illustrated. Like parts will be given like reference numerals. It should be appreciated that the operation of the valve assembly 150 will be substantially similar to those valves described above. Particularly illustrated in FIG. 11 is a center plate 152 of the valve assembly 150. In this embodiment, the valve assembly 150 modified from the valve assembly 100 by the inclusion of a diaphragm 154. The basic purpose of the diaphragm 154 is to prevent leakage past the spool 110. Additionally, in this embodiment, the fluid used to drive the operation of the valve assembly 150 is pressurized air. In other words, the valve assembly 150 can be pneumatically operated. However, it should be appreciated that any of the valve assemblies shown and described herein can be used with any suitable fluid. In this embodiment, a control pressure is applied through a control valve (not shown) that can be a microvalve such as was described above. The control pressure is preferably applied via an inlet 156. When high pressure is applied, the diaphragm 154 forces the spool 110 to the right (as viewing the Figure). Such motion of the spool 110 closes a flow path between a discharge port 158 and a load port 160. Thus, flow to a crankcase (such as was described above) will be substantially stopped. At the same time, a flow path between a port 162 and a port 164 (suction duct) is opened. This creates a flow between the crankcase and the suction duct causing the compressor to upstroke. With the application of low pressure via the inlet 156, the reaction through the small orifice 114 of the reaction pin 112 forces the spool to the left. Such movement creates the effect of opening the flow path between the port 158 and the port 160 while closing the flow path between the port 162 and the port 164. Variable feedback can be provided by changing the discharge acting through the orifice 114 on the reaction pin 112. An additional port 166 is also added in this embodiment of the valve assembly 150 to vent the back side of the diaphragm 154 to the suction. A second port 168 to suction can also be included adjacent the reaction pin 112 to bleed fluid from that end of the valve assembly 150. Although the orientation of the various ports described above are shown in a specific manner, it should be appreciated that the ports can be oriented in any suitable manner to facilitate the position and operation of the valve assembly 150 according to the desired use.

It should be appreciated that any of the embodiments described above can be configured to be operable with either a hydraulic fluid source or a pneumatic fluid source with minor modifications that would be known to those of ordinary skill in the art.

The principle and mode of operation of this invention have been described in its preferred embodiments. However, it should be noted that this invention may be practiced otherwise than as specifically illustrated and described without departing from its scope.

### Index of Reference Numerals

10 valve assembly
12 first layer (cover plate)
14 second layer (center plate)
16 third layer (port plate)
18 front surface of the second layer
20 back surface of the second layer
22 large holes
24 microvalve
26A, 26B tank ports
27A, 27B spool ports
28A, 28B supply ports
30 first channel
32A, 32B opposed bores
34A, 34B opposed ducts
36 second channel
38 bore
40 cut out portion
42 spool
43 spool valve
44 teardrop opening
46 pressure balancing bore
47 side face
48 supply bore
49 opposite side face
50 tank bore
51 spring
52 load bore
53 plug
54 discharge bore
56 first microvalve plate
58 second microvalve plate
60 third microvalve plate
62A, 62B openings
64A, 64B electrical contacts
66 ribs
70 spine
72 elongate beam
74A, 74B opposed blocker ends
75 hinge
76A, 76B first relatively small openings
77A, 77B relatively large openings
78A, 78B second relatively small openings
100 valve assembly
102 spool cover plate
104 bond pads
109 cavity
110 spool
112 reaction pin
114 orifice
116 spring cavity
118 plug
120 crankcase
120a discharge duct
121 spring
122 suction ducts
150 valve assembly
152 center plate of valve assembly
154 diaphragm
156 inlet
158 discharge port
160 load port
162 port
164 suction port
166 port
168 second suction port
L1 Line 1
L2 Line 2

What is claimed is:

1. A microvalve for controlling the operation of a first valve comprising:
a plurality of layers defining a body, the body having a chamber and a plurality of ports in fluid communication with the chamber;
a movable portion positioned within the chamber, the movable portion being selectively moved to control a fluid flow in a first fluid circuit;
wherein the first valve is moved to a first position when there is a fluid flow from a first fluid source through the chamber, and the first valve is moved to a second position when there is a fluid flow from the first valve through the chamber to a first fluid reservoir.

2. The microvalve defined in claim 1 wherein the first fluid circuit comprises the first fluid source and the first fluid reservoir;
wherein the movable portion is selectively movable to one of:
allow the fluid flow from the first fluid source through the chamber to actuate the first valve; and
allow the first fluid flow from the first valve to the first fluid reservoir to de-actuate the first valve.

3. The microvalve defined in claim 1 wherein the fluid flow from the chamber to the first valve actuates the first valve, and the fluid flow from the first valve to the chamber de-actuates the first valve.

4. The microvalve defined in claim 3 further comprising a second fluid circuit having a load and a second fluid reservoir.

5. The microvalve defined in claim 4 wherein actuation of the first valve by the microvalve allows fluid flow from a second source through the first valve to the load.

6. The microvalve defined in claim 5 wherein de-actuation of the first valve by the microvalve allows fluid flow from the load through the first valve to the second fluid reservoir.

7. A microvalve device comprising:
a microvalve pilot valve including a first layer, a third layer having a plurality of openings formed therethrough, and a second layer being positioned between the first layer and the third layer, the second layer including a chamber in fluid communication with the openings, and a movable member for selectively controlling fluid flow through the chamber and between the openings; and
a pilot operated valve including a first plate, a third plate, and a second plate positioned between the first plate and the third plate;
wherein the first plate includes a plurality of ports in fluid communication with the openings of the microvalve, a pressure apply channel, and a pressure release channel;
the second plate includes the pressure apply channel and the pressure release channel, both of the channels being in fluid communication with a spool portion of the pilot operated valve, the spool portion being selectively movable to allow flow from a second source of fluid to a load;
the third plate includes:
a first source port in fluid communication with a first fluid source, the pressure apply channel, one of the first plate ports, and one of the microvalve openings;
a first reservoir port in fluid communication with a first reservoir, the pressure release channel, one of the first plate ports, and one of the microvalve openings;
a second source port in fluid communication with the second source of fluid; and
a load port in fluid communication with the load.

8. The microvalve device defined in claim 7 wherein the pilot operated valve is a macro-sized valve.

9. The microvalve device defined in claim 7 wherein the pilot operated valve is a plate valve.

10. The microvalve device defined in claim 8 wherein the pilot operated valve is a plate valve.

11. The microvalve device defined in claim 7 wherein the pilot operated valve is a spool valve.

12. The microvalve device defined in claim 8 wherein the pilot operated valve is a spool valve.

13. The microvalve device defined in claim 12 wherein the spool valve includes a spool that is positioned within a cutout portion of the second plate, and is configured for axial movement within the cutout portion.

14. The microvalve defined in claim 13 wherein the spool comprises a first opening and a second opening formed therethrough such that the spool valve is actuated when the first opening is over the load port and source port and the second opening is blocked, and the spool valve is de-actuated when the first opening is over the load port and the second opening is over a second reservoir port and the spool blocks the supply port.

15. A plate valve comprising:
a first plate defining a plurality of ports connected with a second plate;
a second plate defining a chamber, the chamber having a spool positioned therein the spool being movable between a first position and a second position; and a plurality of fluid channels, the fluid channels being in fluid communication with the plurality of ports; and
a third plate including a first port connected with a first source of fluid, a second port connected with a reservoir; a third port connected with a second source of fluid; and a fourth port connected with a load; wherein one of the fluid channels connects the first source of fluid with one of the plurality of openings of the first plate and the spool, another of the fluid channels connects the reservoir with one of the openings of the first plate and the spool;
wherein movement of the spool is caused by at least one of fluid moving from the first source of fluid to the spool, and from the spool to the reservoir; and
movement of the spool creates a fluid path between the second source of fluid and the load.

16. The plate valve defined in claim 15 wherein the valve is macro-sized.

17. The plate valve defined in claim 16 wherein the plurality of openings of the first plate are in fluid communication with a microvalve, the plate valve acting as a pilot valve for the plate valve.

18. The plate valve defined in claim 15 wherein the spool is a round spool.

19. The plate valve defined in claim 18 further comprising a diaphragm, the diaphragm being positioned at one end of the spool.

20. The plate valve defined in claim 19 wherein the fluid is one of a hydraulic fluid and air.
